(19) United States
(12) Patent Application Publication
(10) Pub. No.: US 2006/0122748 A1
(43) Pub. Date: Jun. 8, 2006

(54) SYSTEM AND METHOD FOR DIAGNOSING REMOTE VEHICLE USING TELEMATICS SYSTEM

(76) Inventor: SEONG TAEG NOU, Icheon-shi Kyungki-do (KR)

Correspondence Address: IPLA P.A., 3580 WILSHIRE BLVD., 17TH FLOOR, LOS ANGELES, CA, 90010, US

(21) Appl. No.: 11/161,984

(22) Filed: Aug. 24, 2005

(30) Foreign Application Priority Data
Dec. 4, 2004 (KR) 10-2004-0101549

(51) Int. Cl. G01M 17/00; G06F 17/00

(52) U.S. Cl. 701/29; 701/2

(57) ABSTRACT

A system and method for diagnosing a remote vehicle using a telematics system is provided. The system includes a communication terminal for generating and transmitting a remote diagnosis service request signal, and informing a user of vehicle diagnosis information; a service providing center for receiving the remote diagnosis service request signal and transmitting a remote diagnosis request signal, and transmitting the vehicle diagnostic information to the communication terminal; and a telematics terminal for receiving the remote diagnosis request signal, and diagnosing a car status to generate and transmit the vehicle diagnostic information to the service providing center.

### BACKGROUND OF THE INVENTION

1. Field of the Invention

The present invention relates to a telematics system, and more particularly, to a system and method for diagnosing a remote vehicle using a telematics system, in which the vehicle equipped with the telematics system can be diagnosed and checked in status using a communication terminal at a remote place.

2. Description of the Related Art

In recent years, a telematics system is one of technologies attracting attention. The telematics system detects occurrence of vehicle accident or theft, guides a vehicle running path, and provides a vehicle driver with a variety of other information using a mobile communication method and a position tracing method associated with Internet. In other words, the telematics system provides information through a vehicle based on a Global Positioning System (GPS) using a mobile communication system and a GPS satellite. Accordingly, the telematics system is expected to provide a variety of mobile communication services, such as traffic information, countermeasure to an emergency situation, remote vehicle diagnosis, the use of Internet (for example, financial transaction, provision of news, and transmission and reception of e-mail), using the GPS, a wireless communication network and an Internet network.

One of the reasons why the telematics system attracts attention is that it creates a newly conceptive value added service, which is able to maximize a synergy effect by merging an automobile industry with an Information Telecommunication (IT) industry.

Accordingly, a standardization group of telematics is provided. In the standardization group, there are being standardized an operation and a function of each constituent part of the telematics system, a communication protocol between the constituent parts, and services using a communication network.

If a telematics service is realized, a car can be reconstructed through a wire or wireless communication and broadcasting network, using Internet, which is a third space following an office space and a home space, and can be associated with home networking and office automation through a hetero communication and broadcasting network and an intelligent terminal, thereby providing a service for home and office even to the car without interruption.

Together with the spotlight of a telematics technology and the development of the telematics system, a variety of service contents satisfying a user's desire are being required.

### SUMMARY OF THE INVENTION

Accordingly, the present invention is directed to a system and method for diagnosing a remote vehicle using a telematics system that substantially overcomes one or more of the limitations and disadvantages of the conventional art.

An object of the present invention is to provide a system and method for diagnosing a remote vehicle using a telematics system, in which the vehicle equipped with the telematics system can be diagnosed and checked in status using a communication terminal at a remote place.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims as well as the appended drawings.

To achieve the above and other objects and advantages, and in accordance with the purpose of the invention, as embodied and broadly described herein, there is provided a system for diagnosing a remote vehicle using a telematics system, the system including: a communication terminal for generating and transmitting a remote diagnosis service request signal upon reception of a remote diagnosis service request from a user, and informing the user of vehicle diagnosis information upon reception of the vehicle diagnosis information responsive to the remote diagnosis service request signal; a service providing center for receiving the remote diagnosis service request signal and transmitting a remote diagnosis request signal, and transmitting the vehicle diagnostic information to the communication terminal upon reception of the vehicle diagnostic information responsive to the remote diagnosis request signal; and a telematics terminal for receiving the remote diagnosis request signal, and diagnosing a car status to generate and transmit the vehicle diagnostic information to the service providing center.

In another aspect of the present invention, there is provided a method for diagnosing a remote vehicle using a telematics system having a communication terminal, a service providing center and a telematics terminal, the method including the steps of: when a user inputs a control request for diagnosing a vehicle at a remote place, to the communication terminal, generating and transmitting a remote diagnose service request signal in the communication terminal; in the service providing center, receiving the remote diagnose service request signal, and transmitting a vehicle diagnose request signal; in the telematics terminal, receiving the vehicle diagnose request signal, diagnosing a car status, generating a vehicle diagnostic information, and the transmitting the generated vehicle diagnostic information to the service providing center; in the service providing center, receiving the vehicle diagnostic information in response to the remote diagnostic request signal, and transmitting the received vehicle diagnostic information to the communication terminal; and in the communication terminal, receiving the control result and informing the user of the received control result.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to aid in understanding the invention and are incorporated into and constitute a part of this application, illustrate embodiment(s) of the invention and together with the description serve to explain the principles of the invention. In the drawings:

FIG. 1 illustrates a construction of a system for diagnosing a remote vehicle using a telematics system according to the present invention;

FIG. 2 illustrates a construction of a telematics terminal according to the present invention;

FIG. 3 is a flowchart illustrating a method for diagnosing a remote vehicle using a telematics system according to the first embodiment of the present invention; and

FIG. 4 is a flowchart illustrating a method for diagnosing a remote vehicle using a telematics system according to the second embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numerals will be used throughout the drawings to refer to the same or like parts.

According to the present invention, a telematics system subscriber connects to a vehicle equipped with a telematics terminal, and diagnoses and checks a status of the vehicle, through a telematics system using a communication terminal at a remote place.

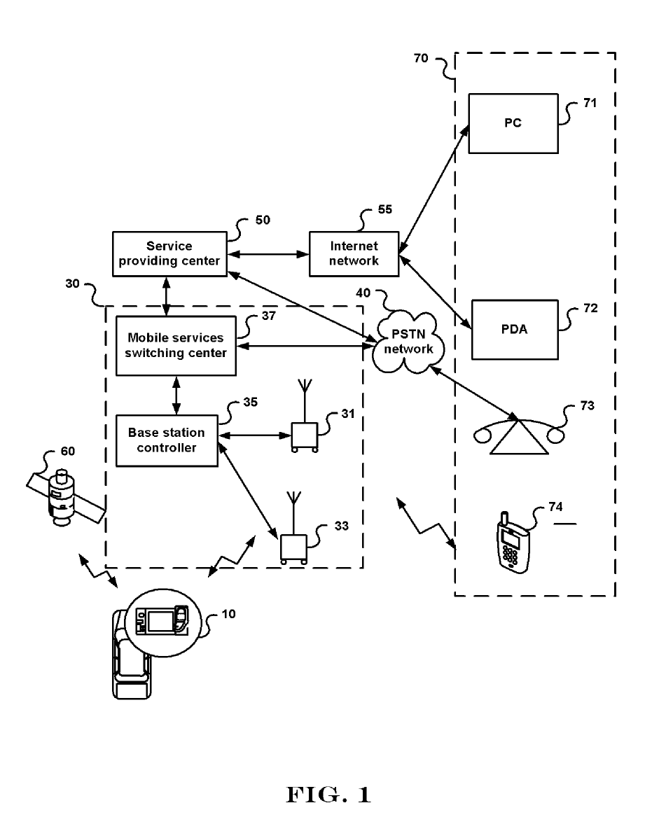

FIG. 1 illustrates a construction of a system for diagnosing the remote vehicle using the telematics system according to the present invention.

The inventive diagnosing system using the telematics system includes the telematics terminal 10, a mobile communication network 30, a Public Switching Telecommunication Network (PSTN) 40, a service providing center 50, an Internet network 55, and the communication terminal 70.

The telematics terminal 10 receives position information from an artificial satellite 60, maps the received position information to a previously stored map data, and displays a car's position on a displaying device such as a Liquid Crystal Display (LCD). Further, the telematics terminal 10 diagnoses a car status (that is, a status of a controller, such as an Electronic Control Unit (ECU) and a Transmission Control Unit (TCU) for controlling a electro-mechanic system and a multimedia system such as Audio/Video (AV) instrument navigation, statuses of car door, hood, trunk and window, and the like) through a sensor connected to a car's interior or exterior, and displays information on the diagnosed car status on the displaying device. Even when the telematics terminal 1 0 receives a remote diagnosis request signal from the service providing center 50 through the mobile communication network 30, it diagnoses the car status, collects the information on the diagnosed car status, and transmits the collected information to the service providing center 50 through the mobile communication network 30. The telematics terminal 10 can be connected with the mobile communication network 30 using a portable mobile communication terminal 10-1, or can be connected with the mobile communication network 30 using its internally installed wireless communication unit. Through the telematics terminal 10, the telematics system subscriber can receive traffic information through the mobile communication network 30, display the received traffic information on the LCD, and receive a service of information such as a current traffic situation.

The service providing center 40 is connected with the mobile communication network 30, the PSTN 40, and the Internet network 55. The service providing center 40 is wireless connected with the telematics terminal 10 through the mobile communication network 30, to receive the vehicle diagnostic information from the telematics terminal 10 and transmit the received vehicle diagnostic information to the telematics system subscriber through the mobile communication network 30, the PSTN 40 or the Internet network 55 connecting with the telematics system subscriber. The transmitted vehicle diagnostic information can be a character, a graphic icon, voice, and the like depending on a type of a communication network connecting with the subscriber. For example, in case where the subscriber connects to the service providing center 40 through the PSTN being a wire communication network, the vehicle diagnostic information can be the voice. In case where the subscriber connects to the service providing center 40 through a cell phone or a Portable Digital Assistants (PDA) being a mobile communication terminal, the vehicle diagnostic information can be the voice, the character, and/or the graphic icon. Further, the service providing center 40 should have a number of the telematics terminal of each remote vehicle diagnostic service subscriber, and an authentication password and/or a resident registration number for the telematics terminal, to authenticate the subscriber and allow the connection to the corresponding telematics terminal.

The communication terminal 70 can be any one of a Personal Computer (PC) 71 connecting to the service providing center 50 through the Internet network 55, the PDA 72 connecting to the service providing center 50 through the Internet network 55 or the mobile communication network 30, a line telephone set 73 connected to the service providing center 50 through the PSTN 40, and the cell phone 74 connecting to the service providing center 50 through the mobile communication network 30. According to the present invention, the communication terminal 70 receives the vehicle diagnostic information from the service providing center 50, and informs a user of the received vehicle diagnostic information through the LCD, a monitor or a speaker.

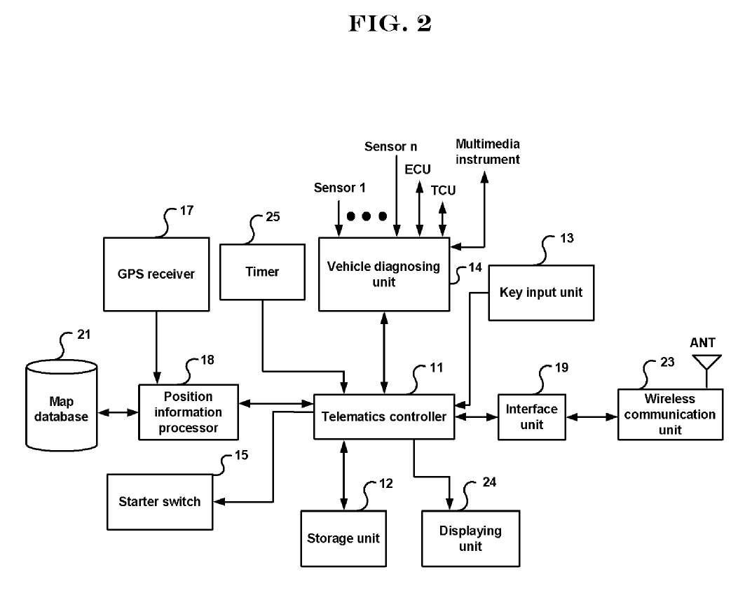

FIG. 2 illustrates a construction of the telematics terminal according to the present invention.

Referring to FIG. 2, a construction and an operation of the telematics terminal will be described below.

The telematics terminal 10 includes a telematics controller 11, a storage unit 12, a key input unit 13, a vehicle diagnosing unit 14, a starter switch 15, a GPS receiver 17, a position information processor 18, an interface unit 19, a map database 21, the wireless communication unit 23, a displaying unit 24, and a timer 25. In case where the wireless communication unit 23 is of a type internally installed, the interface unit 19 is not required.

The telematics controller 11 controls a general operation of the telematics terminal 10. The storage unit 12 includes a region for storing a control program for controlling the operation of the telematics terminal 10; a region for temporarily storing data, which is generated during the execution of the control program; and a region for storing a user data such as the vehicle diagnostic information and the authentication password, which is used for authentication when remote diagnosis is requested.

The key input unit 13 includes a plurality of alphanumeric keys, function keys, mode keys, end keys, and the like, and generates key data for the keys. The vehicle diagnosing unit 14 detects a status signal of each constituent part of the car from a plurality of sensors, which are positioned at exterior or interior constituent parts of the car, and transmits the detected status signal to the telematics controller 11. The vehicle diagnosing unit 14 can receive the status signal in a direct connection with the plurality of sensors, or can receive the status signal or the vehicle diagnostic information of each constituent part of the car through the ECU or TCU connected with the plurality of sensors. The vehicle diagnosing unit 14 transmits a diagnosis request signal for requesting to diagnose the car status, to the ECU and the TCU, and receives the status signal or the vehicle diagnostic information through the ECU and TCU. The ECU and the TCU diagnose the car status in response to the diagnosis request signal, and transmits the diagnosed car status to the vehicle diagnosing unit 14. The sensors can be exemplified as a collision sensor for sensing the collision at a front or rear of the car, an airbag sensor for sensing the activation of the airbag when a sensed value of the collision sensor is larger than a predetermined value, a sensor for checking an amount of car's oil, and a sensor for sensing the opening or closing of the window, the door, and the trunk. Further, the vehicle diagnosing unit 14 is connected with a multimedia instrument such as an AV instrument, to diagnose the multimedia instrument. The vehicle diagnosing unit 14 receives and collects the car status signals or the vehicle diagnostic information, and outputs the collected status signals or vehicle diagnostic information to the telematics controller 11.

The telematics controller 11 transmits the collected vehicle diagnostic information to the mobile communication network 30 through the wireless communication unit 23.

The displaying unit 24 displays a variety of information, such as operation mode and state of the telematics system, and the car status, in a graphic or text format, under the control of the telematics controller 11. The displaying unit 24 can employ the LCD and the like.

The timer 25 counts a time, and provides information on the counted time to the telematics controller 11.

The interface unit 19 is connected with a Universal Asynchronous Receiver and Transmitter (UART)(not shown) of the wireless communication unit 23, and wireless connects the telematics terminal 10 with a base station 33 of FIG. 1. In case where the wireless communication unit 23 is of a type internally installed, the telematics terminal 10 can be configured without the interface unit 19.

The starter switch 15 supplies a power to the vehicle, or starts an engine of the powered vehicle under the control of the telematics controller 11. When the car status is diagnosed, the telematics terminal 10 and the vehicle should be in a powered state. Therefore, the telematics controller 11 should control the starter switch 15 to supply the power to the vehicle and start the engine of the powered vehicle.

Further, even when a car key is removed, a minimal power should be supplied to the telematics controller 11, the wireless communication unit 23, and the interface unit 19 in order to enable the telematics terminal 10.

Or, when the telematics terminal 10 receives the remote diagnosis request signal through the wireless communication unit 23 and the interface unit 19 while activating the telematics controller 11, the wireless communication unit 23 and the interface unit 19 with the supplied minimal power, the power can be also supplied to each of the constituent parts of the car.

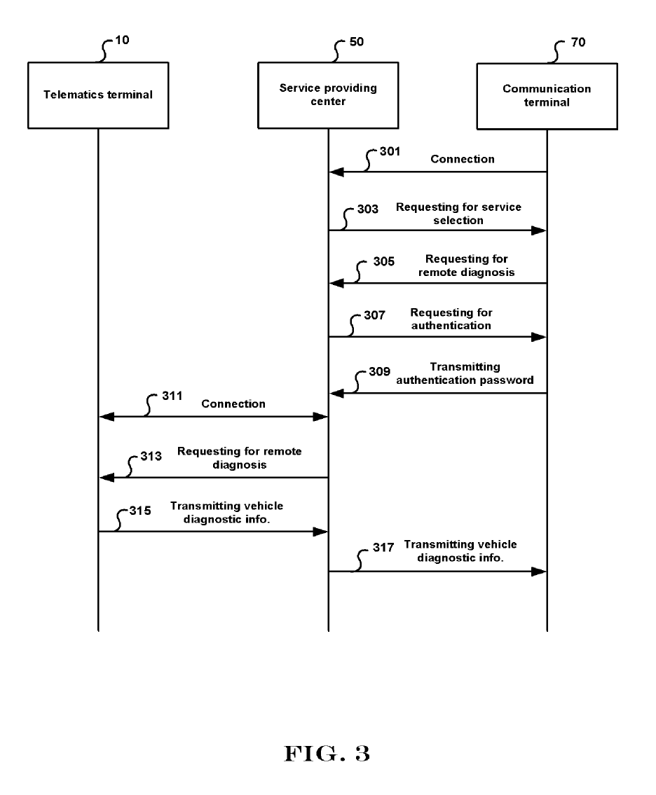

FIG. 3 is a flowchart illustrating a method for diagnosing the remote vehicle using the telematics system according to the first embodiment of the present invention.

Referring to FIGS. 1 to 3, the inventive method for diagnosing the vehicle at the remote place will be described below.

The telematics system subscriber should subscribe to the service providing center 50 for a remote vehicle diagnosis service. The service providing center 50 should receive information on whether or not the user subscribes for the remote vehicle diagnosis service, and an inherent authentication password from the subscriber. When the communication terminal 70 is the line telephone set 73, the inherent authentication password can be a numeric password. When the communication terminal 70 is the PC 71, the PDA 72, and the portable phone 74, the inherent authentication password can be an IDentification (ID) and a password such as a numeral or a character. When the communication terminal 70 is the line telephone set 73, the service providing center 50 uses an Automatic Response System (ARS). It is desirable that additional authentication information such as a resident registration number is requested using the ARS, to reinforce safety.

When the communication terminal 70 receives a service providing center connection command from the subscriber, it connects to the service providing center 50 in Step 301. When the communication terminal 70 is the line telephone set 73, the connection command can be a telephone number of the service providing center 50. When the communication terminal 70 is the Internet, the connection command can be a service request command on a homepage of the service providing center 50.

When the communication terminal 70 connects to the service providing center 50, the service providing center 50 transmits a service selection request signal from in-services in Step 303. The service selection request signal can have a graphic or text format and a voice format, depending on a type of the communication terminal 70. The communication terminal 70 receives the service selection request signal, and checks whether or not to select one of a plurality of services. If it is checked that the vehicle diagnosis service is selected, the communication terminal 70 transmits the remote diagnosis request signal to the service providing center 50 through the corresponding network in Step 305. Then, in Step 307, the service providing center 50 transmits an authentication request signal to the communication terminal 70 to determine whether or not the subscriber, who uses the communication terminal 70 transmitting the diagnosis service request signal, is registered. The communication terminal 70 receives the authentication request signal, receives the authentication password from the subscriber, and transmits the received authentication password to the service providing center 50 in Step 309.

The service providing center 50 receives the authentication password, and compares the received authentication password with a previously stored authentication password and determines whether or not they are the same. If it is determined that they are the same, the service providing center 50 connects to the telematics terminal 10 for the subscriber in Step 311. At this time, a request for the connection is performed by the service providing center 50. It is desirable that the service providing center 50 has an inherent number for distinguishing itself from others.

Only when the telematics terminal 10 receives an incoming call having its own number including the inherent number, it forms a communication path and connects with the service providing center 50.

If the service providing center 50 connects to the telematics terminal 10, it transmits the remote diagnosis request signal for requesting the remote diagnosis, to the telematics terminal 10 in Step 313. Then, the telematics terminal 10 diagnoses the car status through the vehicle diagnosing unit 14 and the position information processor 18, receives the vehicle diagnostic information, and transmits the received vehicle diagnostic information to the service providing center 50 in Step 315.

The service providing center 50 receives the vehicle diagnostic information from the telematics terminal 10, converts the received vehicle diagnostic information suitably to the communication terminal 70, which has requested the remote vehicle diagnosis service, and transmits the converted vehicle diagnostic information to the communication terminal 70 in Step 317. For example, when the communication terminal 70 is the line telephone set 73, the service providing center 50 converts text data of the vehicle diagnostic information into voice data, and transmits the converted voice data to the telematics terminal 70. When the communication terminal is the PC 71, the PDA 72 or the cell phone 74, the service providing center 50 converts the vehicle diagnostic information into the text or graphic, and transmits the converted text or graphic to the telematics terminal 70.

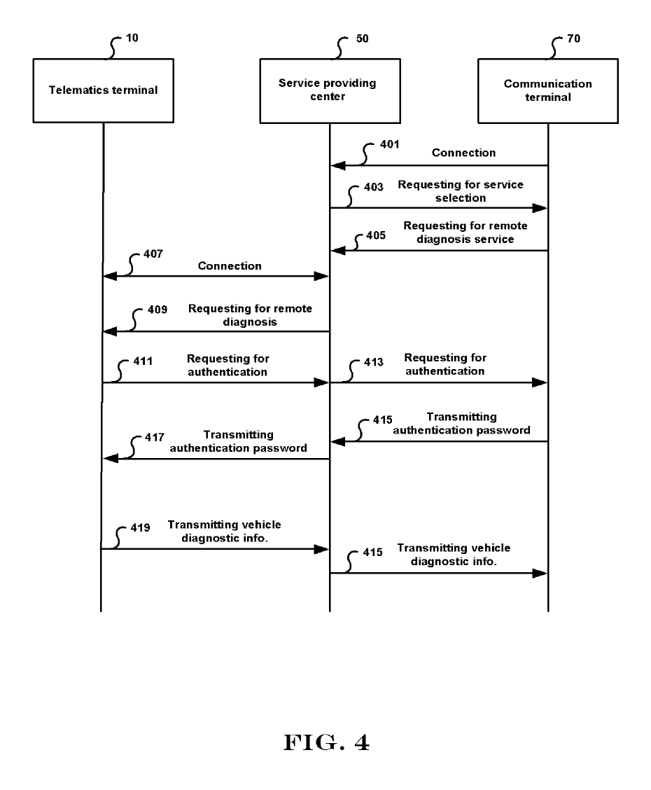

FIG. 4 is a flowchart illustrating a method for diagnosing the remote vehicle using the telematics system according to the second embodiment of the present invention.

The first embodiment illustrate a case where the authentication is performed in the service providing center 50, and the second embodiment illustrates a case where the authentication is performed in the telematics terminal 10.

Steps 401 to 405 of FIG. 4 are the same as the corresponding Steps 301 to 305 of FIG. 3. If the service providing center 50 receives the remote diagnosis request signal from the communication terminal 70 in Step 405, the service providing center 50 connects to the telematics terminal 10 in Step 407. If the service providing center 50 connects to the telematics terminal 10 in the Step 407, it transmits the remote diagnosis request signal to the telematics terminal 10 in Step 409. The telematics terminal 10 receives the remote diagnosis request signal, and transmits an authentication request signal to the service providing center 50 in Step 411.

The service providing center 50 receives the authentication request signal, converts the received authentication request signal into an authentication request signal suitable to the communication terminal 70, and transmits the converted authentication request signal to the communication terminal 70 in Step 413. The communication terminal 70 receives the authentication request signal, and transmits the authentication password to the service providing center 50 in response to the received authentication request signal in Step 415. If so, the service providing center 50 transmits the authentication password to the telematics terminal 10 in Step 417.

The telematics terminal 10 receives the authentication password, and collects and transmits the vehicle diagnostic information to the service providing center 50 in Step 419. Then, the service providing center 50 receives the vehicle diagnostic information, converts the received vehicle diagnostic information into vehicle diagnostic information suitably to the communication terminal 70, and transmits the converted vehicle diagnostic information to the communication terminal 70 in Step 421.

The line telephone set 73 provides the vehicle diagnostic information using the ARS. The cell phone 74, the PC 71 or the PDA 72 provides the vehicle diagnostic information in text or graphic, through a data communication using the ARS or the wireless communication network. In the above description, the voice is provided using the ARS. However, the voice can be provided using a counselor instead of the ARS.

As described above, the present invention has an advantage in that since a car owner can diagnose the vehicle at the remote place, he/she can check the current car status everywhere.

Further, the present invention has an advantage in that the car owner can quickly cope with a car trouble, a car theft, and a car impact.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A system for diagnosing a remote vehicle using a telematics system, the system comprising:
a communication terminal for generating and transmitting a remote diagnosis service request signal upon reception of a remote diagnosis service request from a user, and informing the user of vehicle diagnosis information upon reception of the vehicle diagnosis information responsive to the remote diagnosis service request signal;
a service providing center for receiving the remote diagnosis service request signal and transmitting a remote diagnosis request signal, and transmitting the vehicle diagnostic information to the communication terminal upon reception of the vehicle diagnostic information responsive to the remote diagnosis request signal; and
a telematics terminal for receiving the remote diagnosis request signal, and diagnosing a car status to generate and transmit the vehicle diagnostic information to the service providing center.

2. The system according to claim 1, wherein the service providing center stores a number and an authentication password of the telematics terminal, requests the communication terminal for authentication when receiving a remote control request signal from the communication terminal, receives an authentication password in response to the authentication request, compares the received authentication password with the stored authentication password, and performs the authentication depending on the comparison result.

3. The system according to claim 1, wherein the telematics terminal has its inherent authentication password, requests the communication terminal for authentication through the service providing center when receiving the remote diagnosis service request signal from the communication terminal, receives an authentication password in response to the authentication request, compares the received authentication password with the inherent authentication password, and performs the authentication depending on the comparison result.

4. The system according to claim 1, wherein the communication terminal is a line telephone set.

5. The system according to claim 4, wherein the vehicle diagnostic information transmitted from the service providing center to the communication terminal is voice.

6. The system according to claim 5, wherein the voice is provided from an ARS (Automatic Response System).

7. The system according to claim 1, wherein the communication terminal is a cell phone.

8. The system according to claim 7, wherein the vehicle diagnostic information transmitted from the service providing center to the communication terminal is voice.

9. The system according to claim 7, wherein the vehicle diagnostic information transmitted from the service providing center to the communication terminal is a text.

10. The system according to claim 7, wherein the vehicle diagnostic information transmitted from the service providing center to the communication terminal is a graphic.

11. The system according to claim 1, wherein the communication terminal is a PC (Personal Computer).

12. The system according to claim 11, wherein the vehicle diagnostic information transmitted from the service providing center to the communication terminal is voice.

13. The system according to claim 11, wherein the vehicle diagnostic information transmitted from the service providing center to the communication terminal is a text.

14. The system according to claim 11, wherein the vehicle diagnostic information transmitted from the service providing center to the communication terminal is a graphic.

15. A method for diagnosing a remote vehicle using a telematics system having a communication terminal, a service providing center and a telematics terminal, the method comprising the steps of:
when a user inputs a control request for diagnosing a vehicle at a remote place, to the communication terminal, generating and transmitting a remote diagnose service request signal in the communication terminal;
in the service providing center, receiving the remote diagnose service request signal, and transmitting a vehicle diagnose request signal;
in the telematics terminal, receiving the vehicle diagnose request signal, diagnosing a car status, generating a vehicle diagnostic information, and the transmitting the generated vehicle diagnostic information to the service providing center;
in the service providing center, receiving the vehicle diagnostic information in response to the remote diagnostic request signal, and transmitting the received vehicle diagnostic information to the communication terminal; and
in the communication terminal, receiving the control result and informing the user of the received control result.

16. The method according to claim 15, wherein the service providing center stores a number and an authentication password of the telematics terminal, requests the communication terminal for authentication when receiving a remote diagnosis service request signal from the communication terminal, receives an authentication password in response to the authentication request, compares the received authentication password with the stored authentication password, and performs the authentication depending on the comparison result.

17. The method according to claim 15, wherein the telematics terminal has its inherent authentication password, requests the communication terminal for authentication through the service providing center when receiving a remote diagnosis service request signal from the communication terminal, receives an authentication password in response to the authentication request, compares the received authentication password with the inherent authentication password, and performs the authentication depending on the comparison result.

18. The method according to claim 15, wherein the communication terminal is a line telephone set.

19. The method according to claim 18, wherein the vehicle diagnostic information transmitted from the service providing center to the communication terminal is voice.

20. The method according to claim 19, wherein the voice is provided from an ARS (Automatic Response System).

21. The method according to claim 15, wherein the communication terminal is a cell phone.

22. The method according to claim 21, wherein the vehicle diagnostic information transmitted from the service providing center to the communication terminal is voice.

23. The method according to claim 21, wherein the vehicle diagnostic information transmitted from the service providing center to the communication terminal is a text.

24. The method according to claim 21, wherein the vehicle diagnostic information transmitted from the service providing center to the communication terminal is a graphic.

25. The method according to claim 15, wherein the communication terminal is a PC (Personal Computer).

26. The system according to claim 25, wherein the vehicle diagnostic information transmitted from the service providing center to the communication terminal is voice.

27. The system according to claim 25, wherein the vehicle diagnostic information transmitted from the service providing center to the communication terminal is a text.
